(19) United States
(12) Patent Application Publication
(10) Pub. No.: US 2026/0291076 A1
(43) Pub. Date: Sep. 24, 2026

(54) ANTENNA MODULE

(71) Applicant: PEGATRON CORPORATION, TAIPEI CITY (TW)

(72) Inventors: Jung-Yi Huang, Taipei City (TW); Kuan-Chuan Huang, Taipei City (TW); Hui-An Yang, Taipei City (TW)

(73) Assignee: PEGATRON CORPORATION, TAIPEI CITY (TW)

(21) Appl. No.: 19/445,652

(22) Filed: Jan. 12, 2026

(30) Foreign Application Priority Data
Mar. 20, 2025 (TW) 114110563

(51) Int. Cl. H01Q 13/10; H01Q 5/335

(52) U.S. Cl. CPC H01Q 13/106; H01Q 5/335

(57) ABSTRACT

An antenna module includes a substrate, two antenna units, at least one first microstrip and at least one second microstrip. The substrate includes a first surface and a second surface opposite to each other. The two antenna units are arranged at an interval, have the same polarization, and resonate at a frequency band. Each antenna unit includes a first radiator and a second radiator. The first radiator is disposed on the first surface, and the second radiator is disposed on the second surface. The at least one first microstrip is connected between the two first radiators. The at least one second microstrip is connected between the two second radiators, a length of each of the at least one first microstrip and the at least one second microstrip is 1/2 times a wavelength of the frequency band.

### CROSS-REFERENCE TO RELATED APPLICATION

This application claims the priority benefit of Taiwan application serial no. 114110563, filed on Mar. 20, 2025. The entirety of the above-mentioned patent application is hereby incorporated by reference herein and made a part of this specification.

### BACKGROUND

### Technical Field

The disclosure relates to an antenna module, and in particular relates to an antenna module with good isolation.

### Description of Related Art

With the advancement of technology, the size of electronic devices has decreased while the number of antennas required has increased. How to improve the isolation between two adjacent antenna units with the same polarization has become a research direction in this field.

### SUMMARY

An antenna module is provided in the disclosure, in which two adjacent antenna units with the same polarization have good isolation.

An antenna module of the disclosure includes a substrate, two antenna units, at least one first microstrip, and at least one second microstrip. The substrate includes a first surface and a second surface opposite to each other. The two antenna units are arranged at an interval, have a same polarization, and resonate at a frequency band. Each antenna unit includes a first radiator and a second radiator. The first radiator is disposed on the first surface, and the second radiator is disposed on the second surface. At least one first microstrip is connected between the two first radiators. The at least one second microstrip is connected between the two second radiators, in which a length of each of the at least one first microstrip and the at least one second microstrip is 1/2 times a wavelength of the frequency band.

Based on the above, the antenna module of the disclosure has at least one first microstrip connected between two first radiators, and at least one second microstrip connected between two second radiators. The length of each first microstrip and each second microstrip is 1/2 times the wavelength of the frequency band, so that the phase difference between two antenna units is approximately 180 degrees, thereby achieving good isolation between adjacent antenna units with the same polarization.

### BRIEF DESCRIPTION OF THE DRAWINGS

FIG. 1 is a schematic diagram of an antenna module according to an embodiment of the disclosure.

FIG. 2 is a three-dimensional schematic diagram of FIG. 1 with the substrate hidden.

FIG. 3 is a schematic diagram of the antenna module of FIG. 1 on the first surface of the substrate.

FIG. 4 is a schematic diagram of the antenna module of FIG. 1 on the second surface of the substrate.

FIG. 5A is a schematic diagram of the antenna module of FIG. 1 in the X-Z plane.

FIG. 5B is a radiation pattern diagram of the antenna module in FIG. 1 in the X-Z plane.

FIG. 5C is a schematic diagram of the antenna module of FIG. 1 in the Y-Z plane.

FIG. 5D is a radiation pattern diagram of the antenna module of FIG. 1 in the Y-Z plane.

FIG. 5E is a schematic diagram of the antenna module of FIG. 1 in the X-Y plane.

FIG. 5F is a radiation pattern diagram of the antenna module of FIG. 1 in the X-Y plane.

FIG. 6 is a relationship diagram of the frequency-S parameter of the antenna module of FIG. 1.

FIG. 7 is a schematic diagram of an antenna module according to another embodiment of the disclosure.

FIG. 8 is a schematic diagram of an antenna module according to another embodiment of the disclosure.

FIG. 9 is a schematic diagram of an antenna module according to another embodiment of the disclosure.

### DETAILED DESCRIPTION OF DISCLOSED EMBODIMENTS

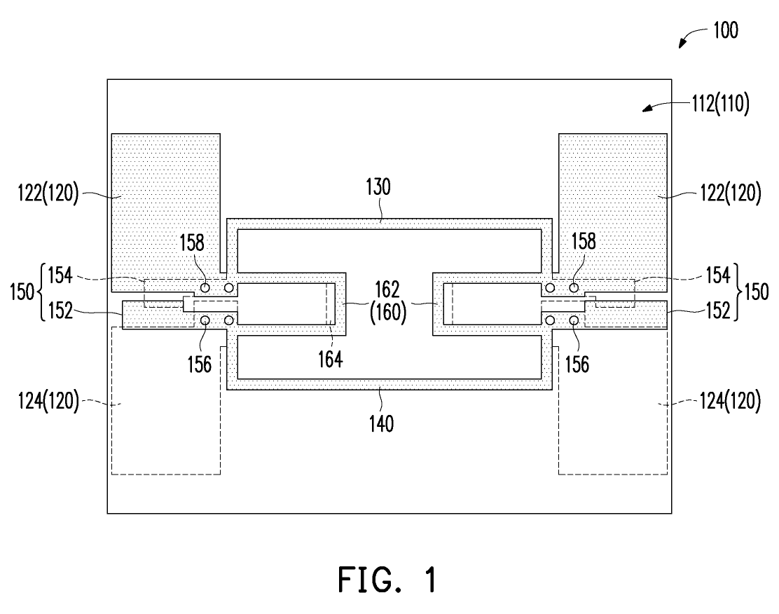

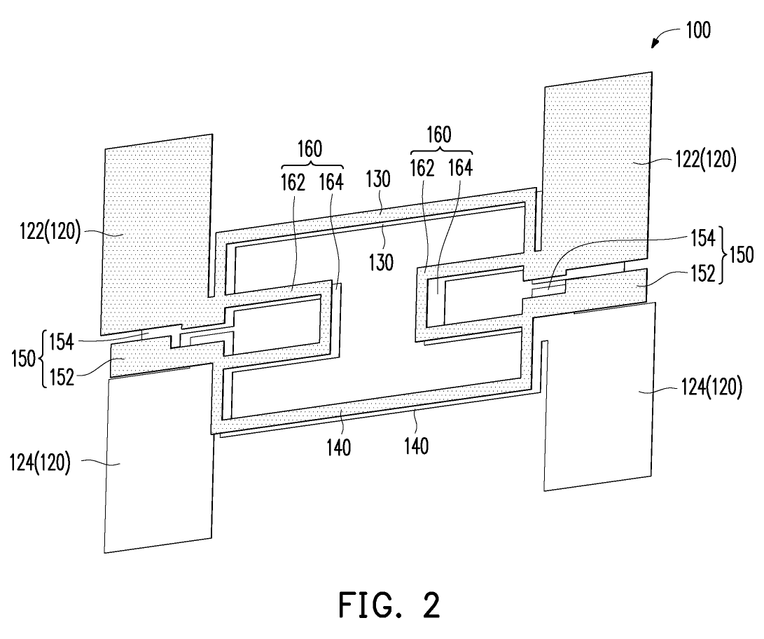

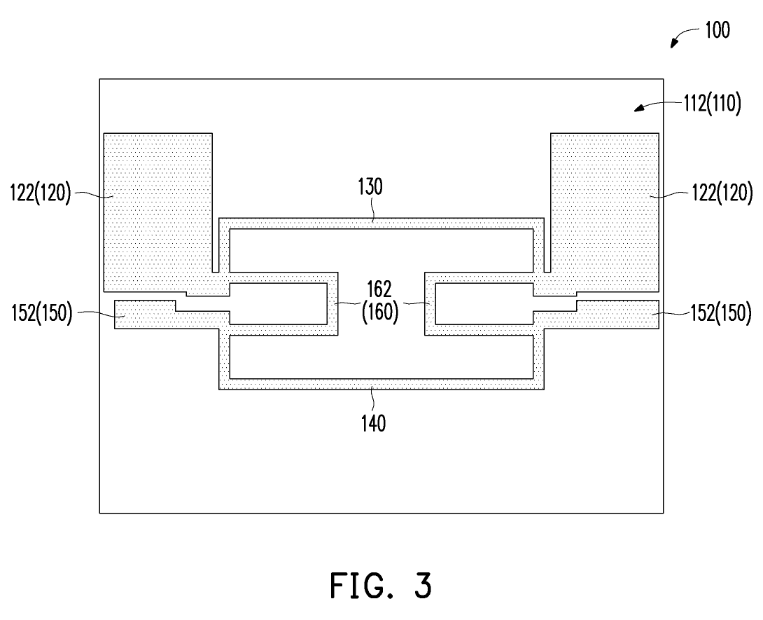

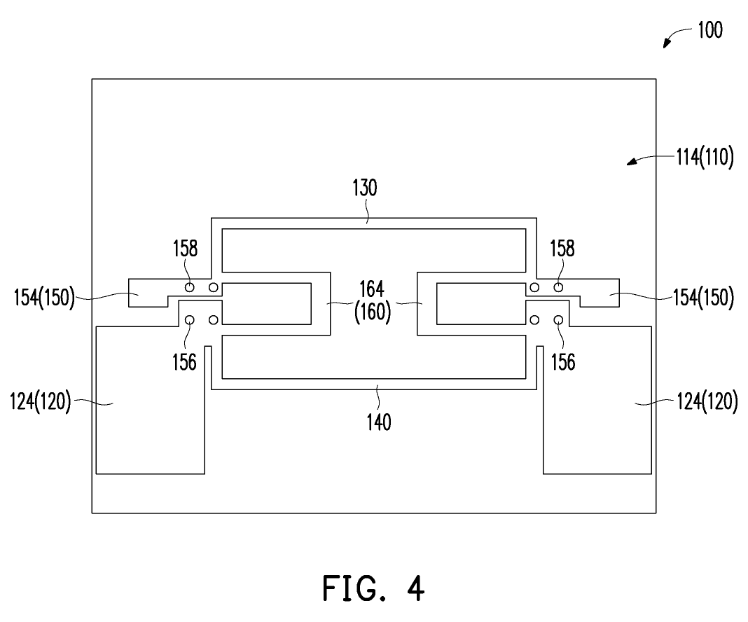

FIG. 1 is a schematic diagram of an antenna module according to an embodiment of the disclosure. FIG. 2 is a three-dimensional schematic diagram of FIG. 1 with the substrate hidden. FIG. 3 is a schematic diagram of the antenna module of FIG. 1 on the first surface of the substrate. FIG. 4 is a schematic diagram of the antenna module of FIG. 1 on the second surface of the substrate. It should be noted that in order to clearly distinguish the elements on different surfaces of the substrate 110, the elements on the first surface 112 are represented by dots.

Referring to FIGS. 1 to 4, an antenna module 100 of this embodiment includes the substrate 110, two antenna units 120, at least one first microstrip 130, and at least one second microstrip 140. The substrate 110 includes a first surface 112 and a second surface 114 opposite to each other. The two antenna units 120 are arranged at an interval, in which one antenna unit 120 is located on the left side of the diagram, and another antenna unit 120 is located on the right side of the diagram. The two antenna units 120 have the same polarization, which may include horizontal polarization, vertical polarization, or circular polarization, but the disclosure is not limited thereto. The two antenna units 120 resonate at the same frequency band. In this embodiment, the frequency band is 6 GHz to 7 GHz, but the frequency band is not limited thereto.

Each antenna unit 120 includes a first radiator 122 and a second radiator 124. In this embodiment, as shown in FIG. 3, the first radiator 122 of each antenna unit 120 is located on the first surface 112. As shown in FIG. 4, the second radiator 124 of each antenna unit 120 is located on the second surface 114.

In this embodiment, the length of each antenna unit 120 is 1/2 times the wavelength of the frequency band. More specifically, the length of each of the two first radiators 122 and the two second radiators 124 is 1/4 times the wavelength of the frequency band.

The at least one first microstrip 130 is disposed between the two antenna units 120 to connect the two first radiators 122. The at least one second microstrip 140 is disposed between the two antenna units 120 to connect the two second radiators 124. The length of each of the first microstrips 130 and the second microstrips 140 is 1/2 times the wavelength of the frequency band. Such a design allows for a phase difference of approximately 180 degrees between the two antenna units 120, thereby achieving good isolation between the two adjacent antenna units 120.

Therefore, in this embodiment, the distance between the two antenna units 120 may be less than 0.6 times the wavelength of this frequency band, for example, less than 0.5 times the wavelength. This is compared with the known requirement that the distance must be at least one wavelength of the frequency band coupled by the antenna. The antenna module 100 of this embodiment may shorten the distance between the two antenna units 120 and reduce the overall size.

In this embodiment, the antenna module 100 further includes two impedance adjustment components 150 for adjusting the impedance bandwidth of the coupled frequency band. In this embodiment, a portion of the projection of each impedance adjustment component 150 on the first surface 112 is located in the space between the projections of the corresponding first radiator 122 and the second radiator 124 on the first surface 112, and another portion of the projection of each impedance adjustment component 150 on the first surface 112 overlaps with the projections of the corresponding first radiator 122 and/or the second radiator 124 on the first surface 112.

Each impedance adjustment component 150 includes a first impedance adjustment section 152 and a second impedance adjustment section 154. As shown in FIG. 3, the first impedance adjustment section 152 of each impedance adjustment component 150 is located on the first surface 112. As shown in FIG. 4, the second impedance adjustment section 154 of each impedance adjustment component 150 is located on the second surface 114. Each first impedance adjustment section 152 is connected to a corresponding second radiator 124 through a first through hole 156, and each second impedance adjustment section 154 is connected to a corresponding first radiator 122 through a second through hole 158.

Furthermore, in this embodiment, the at least one first microstrip 130 includes two first microstrips 130. As shown in FIG. 3, one of the two first microstrips 130 is disposed on the first surface 112 and is connected to the two first radiators 122. As shown in FIG. 4, the other of the two first microstrips 130 is disposed on the second surface 114 and is connected to the two second impedance adjustment sections 154, and is connected to the two first radiators 122 through the two second through holes 158. Of course, the number of the first microstrips 130 and the method of connecting to the two first radiators 122 are not limited thereto.

In this embodiment, the at least one second microstrip 140 includes two second microstrips 140. As shown in FIG. 4, one of the two second microstrips 140 is disposed on the second surface 114 and is connected to the two second radiators 124. As shown in FIG. 3, the other of the two second microstrips 140 is disposed on the first surface 112 and is connected to the two first impedance adjustment sections 152, and is connected to the two second radiators 124 through the two first through holes 156 (FIG. 4). Of course, the number of the second microstrips 140 and the method of connecting to the two second radiators 124 are not limited thereto.

Furthermore, in this embodiment, the antenna module 100 further includes two balun components located between the two antenna units 120. The balun components are configured for current balancing and impedance adjustment. Each balun component 160 is connected to the first radiator 122 and the second radiator 124 of the corresponding antenna unit 120.

Specifically, as shown in FIG. 3, each balun component 160 includes a first balun structure 162. The first balun structure 162 is located on the first surface 112. The first balun structure 162 is connected to the first radiator 122 and a corresponding first impedance adjustment section 152. The first impedance adjustment section 152 is connected to a corresponding second radiator 124 through the first through hole 156. Therefore, the first balun structure 162 is connected to the first radiator 122 and the second radiator 124 on the left side, facilitating the current balancing and impedance adjustment of the first radiator 122 and the second radiator 124 on the left side. In this embodiment, the length of the first balun structure 162 is 1/4 times the wavelength of this frequency band.

As shown in FIG. 4, each balun component 160 includes a second balun structure 164. The second balun structure 164 is located on the second surface 114. The second balun structure 164 is connected to the second radiator 124 and a corresponding second impedance adjustment section 154. Each second impedance adjustment section 154 is connected to a corresponding first radiator 122 through the second through hole 158. Therefore, the second balun structure 164 is connected to the first radiator 122 and the second radiator 124 on the right side, facilitating the current balancing and impedance adjustment of the first radiator 122 and the second radiator 124 on the right side. In this embodiment, the length of the second balun structure 164 is 1/4 times the wavelength of this frequency band.

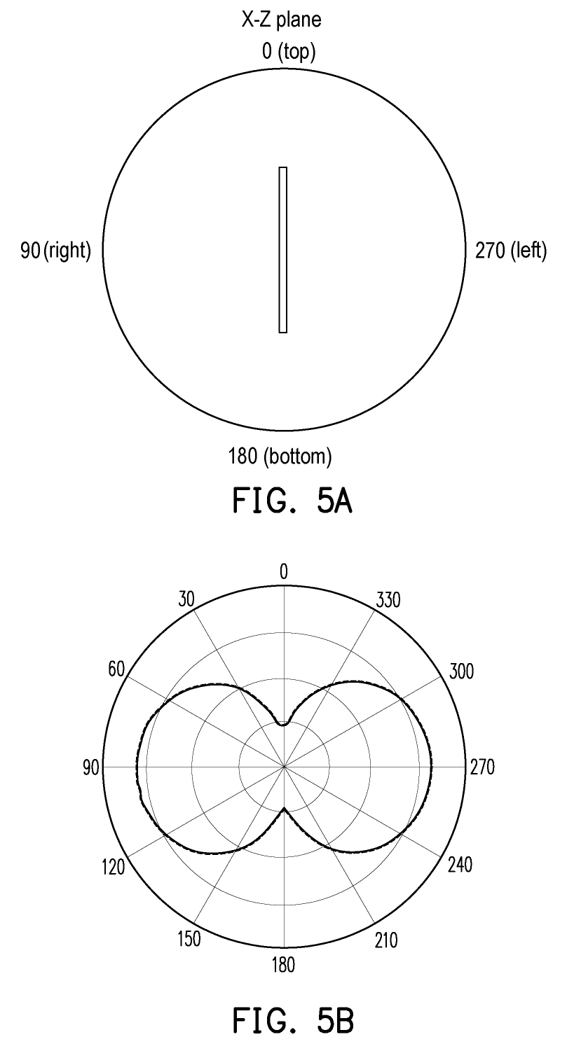

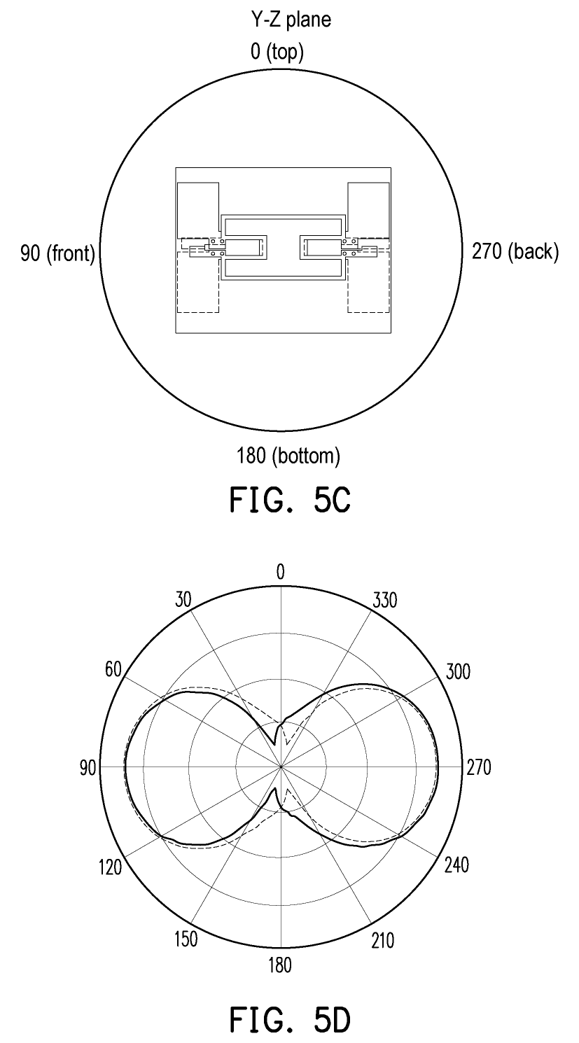

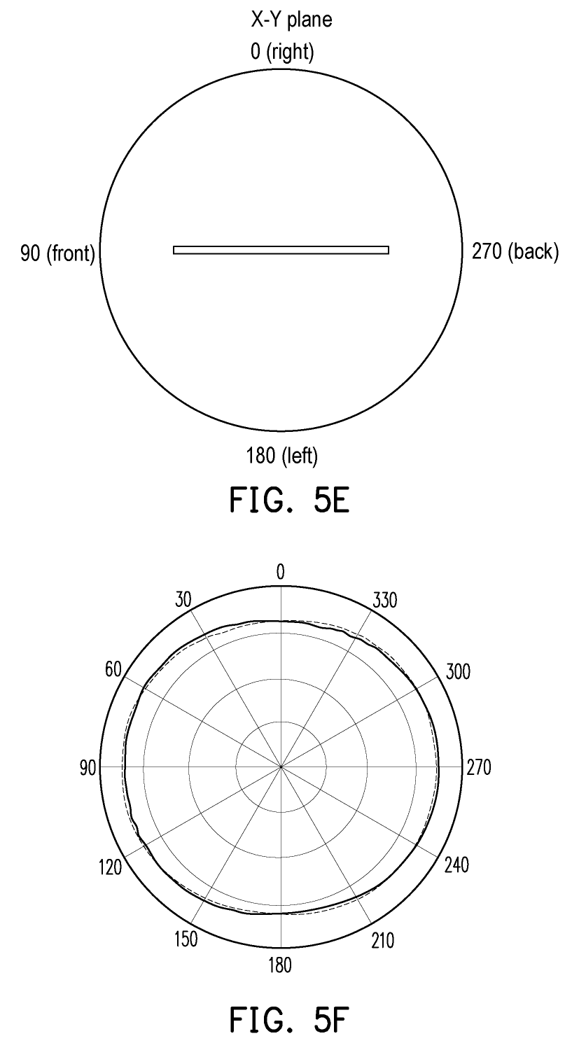

FIG. 5A is a schematic diagram of the antenna module of FIG. 1 in the X-Z plane. FIG. 5B is a radiation pattern diagram of the antenna module in FIG. 1 in the X-Z plane. FIG. 5C is a schematic diagram of the antenna module of FIG. 1 in the Y-Z plane. FIG. 5D is a radiation pattern diagram of the antenna module of FIG. 1 in the Y-Z plane. FIG. 5E is a schematic diagram of the antenna module of FIG. 1 in the X-Y plane. FIG. 5F is a radiation pattern diagram of the antenna module of FIG. 1 in the X-Y plane.

Referring to FIGS. 5A to 5F, the two antenna units 120 of the antenna module 100 of this embodiment have good performance in the X-Z plane, the Y-Z plane, and the X-Y plane, and may even maintain omnidirectionality in the X-Y plane.

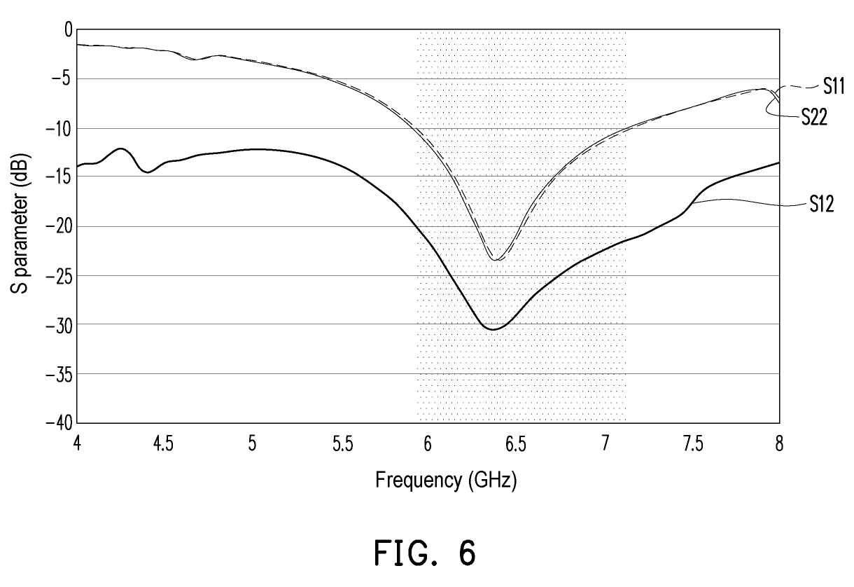

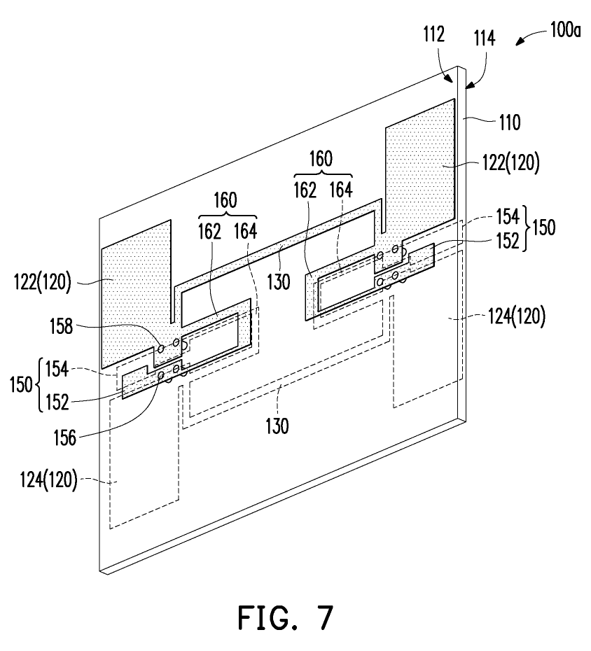

FIG. 6 is a relationship diagram of the frequency-S parameter of the antenna module of FIG. 1. Referring to FIG. 6, the two antenna units 120 of the antenna module 100 of this embodiment have good S11 and S22 performance at this frequency band (6 GHz to 7 GHz). In addition, the two antenna units 120 have an isolation S12 of -20 dB, and thus have good performance.

Other types of antenna modules 100a, 100b, and 100c are introduced below. The same or similar elements as those in the previous embodiment are represented by the same or similar reference numerals, and further details are not repeated herein.

FIG. 7 is a schematic diagram of an antenna module according to another embodiment of the disclosure. Referring to FIG. 7, the difference between the antenna module 100a in FIG. 7 and the antenna module 100 in FIG. 1 is that, in this embodiment, the number of each of the first microstrip 130 and the second microstrip 140 is one. The first microstrip 130 is disposed on the first surface 112 and is connected to the two first radiators 122. The second microstrip 140 is disposed on the second surface 114 and is connected to the two second radiators 124.

Similarly, in this embodiment, the length of each of the first microstrips 130 and the second microstrips 140 is 1/2 times the wavelength of the frequency band. Such a design allows for a phase difference of approximately 180 degrees between the two antenna units 120, thereby achieving good isolation between the two adjacent antenna units 120. Therefore, in this embodiment, the distance between the two antenna units 120 is less than 0.6 times the wavelength of this frequency band, which may reduce the overall size.

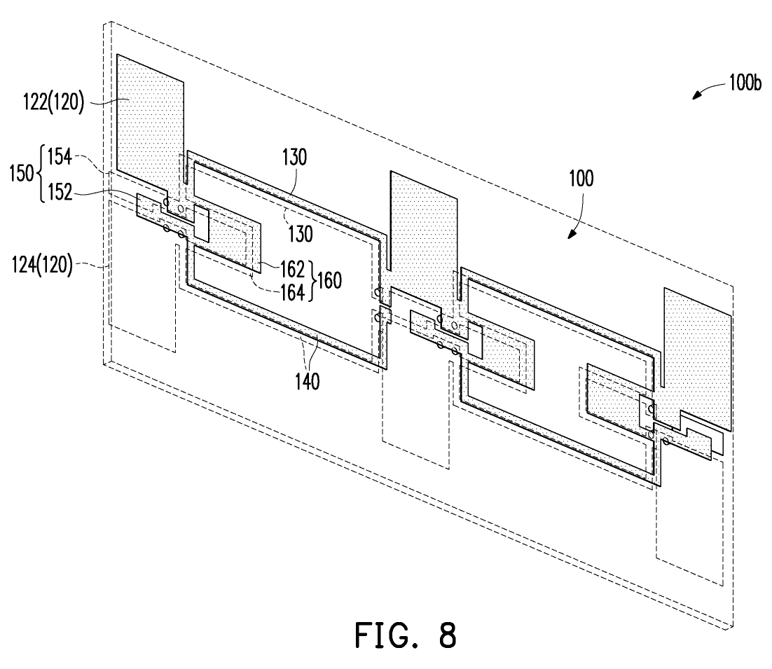

FIG. 8 is a schematic diagram of an antenna module according to another embodiment of the disclosure. Referring to FIG. 8, the difference between the antenna module 100b in FIG. 8 and the antenna module 100 in FIG. 1 is that, in this embodiment, the number of the antenna units 120 in the antenna module 100b is three. The antenna module 100b of FIG. 8 is a structure in which an antenna unit 120, a first microstrip 130, a second microstrip 140, an impedance adjustment component 150, and a balun component 160 are added to the left side of the antenna module 100 of FIG. 1, and this structure is connected to the antenna unit 120 on the left side of the antenna module 100 of FIG. 1.

Similarly, in this embodiment, the length of each of the first microstrips 130 and the second microstrips 140 is 1/2 times the wavelength of the frequency band. Such a design allows for a phase difference of approximately 180 degrees between the two antenna units 120, thereby achieving good isolation between any two adjacent antenna units 120. Therefore, in this embodiment, the distance between any two antenna units 120 is less than 0.6 times the wavelength of this frequency band. Compared to a conventional planar configuration of three antenna units 120, the antenna module 100b of this embodiment may reduce the overall size.

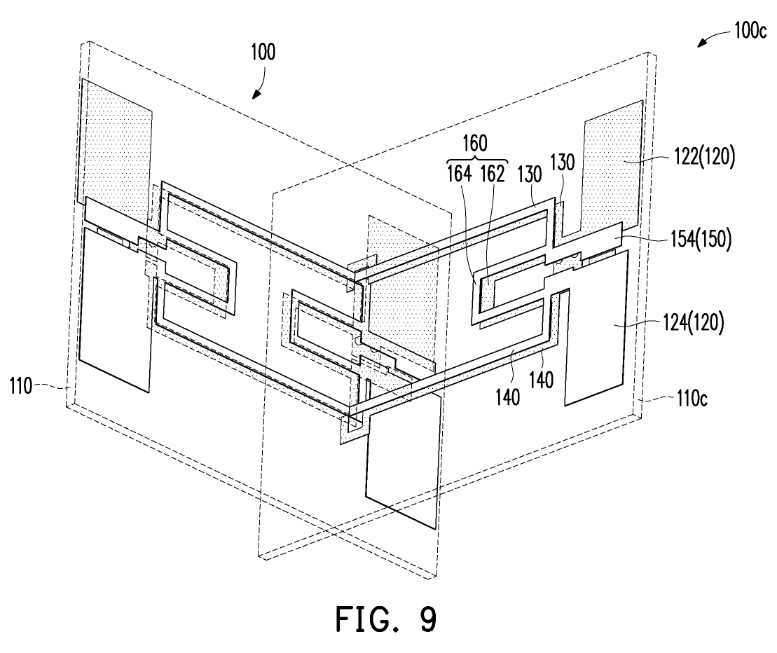

FIG. 9 is a schematic diagram of an antenna module according to another embodiment of the disclosure. Referring to FIG. 9, the difference between the antenna module 100c of FIG. 9 and the antenna module 100b of FIG. 8 is that, in this embodiment, the third antenna unit 120 and the corresponding first microstrip 130, second microstrip 140, impedance adjustment component 150, and balun component 160 are disposed on another substrate 110c, and the two substrates 110 and 110c are on different planes. Such a design may increase the flexibility of antenna design.

Similarly, in this embodiment, the length of each of the first microstrips 130 and the second microstrips 140 is 1/2 times the wavelength of the frequency band. Such a design allows for a phase difference of approximately 180 degrees between the two antenna units 120, thereby achieving good isolation between any two adjacent antenna units 120. Therefore, in this embodiment, the distance between any two antenna units 120 is less than 0.6 times the wavelength of this frequency band. Compared to a conventional three-dimensional configuration of three antenna units 120, the antenna module 100c of this embodiment may reduce the overall size.

To sum up, the antenna module of the disclosure has at least one first microstrip connected to two first radiators, and at least one second microstrip connected to two second radiators. The length of each first microstrip and each second microstrip is 1/2 times the wavelength of the frequency band, so that the phase difference between two antenna units is approximately 180 degrees, thereby achieving good isolation between adjacent antenna units with the same polarization.

What is claimed is:

1. An antenna module, comprising:
a substrate, comprising a first surface and a second surface opposite to each other;
two antenna units, arranged at an interval, the two antenna units having a same polarization and resonating at a frequency band, each of the antenna units comprising:
a first radiator, disposed on the first surface; and
a second radiator, disposed on the second surface;
at least one first microstrip, connected between the two first radiators; and
at least one second microstrip, connected between the two second radiators, wherein a length of each of the at least one first microstrip and the at least one second microstrip is 1/2 times a wavelength of the frequency band.

2. The antenna module according to claim 1, further comprising:
two impedance adjustment components, wherein a portion of a projection of each of the impedance adjustment components on the first surface is located between projections of a corresponding first radiator and a corresponding second radiator on the first surface, each of the impedance adjustment components comprises:
a first impedance adjustment section, disposed on the first surface and connected to the corresponding second radiator through a first through hole; and
a second impedance adjustment section, disposed on the second surface and connected to the corresponding first radiator through a second through hole.

3. The antenna module according to claim 2, wherein the at least one first microstrip comprises two first microstrips, one of the first microstrips is disposed on the first surface and is connected between the two first radiators, and another one of the first microstrips is disposed on the second surface and is connected between the two second impedance adjustment sections.

4. The antenna module according to claim 2, wherein the at least one second microstrip comprises two second microstrips, one of the second microstrips is disposed on the second surface and is connected between the two second radiators, and another one of the second microstrips is disposed on the first surface and is connected between the two first impedance adjustment sections.

5. The antenna module according to claim 2, further comprising:
two balun components, located between the two antenna units, each of the balun components is connected to the first radiator and the second radiator of a corresponding antenna unit.

6. The antenna module according to claim 5, wherein each of the balun components comprises a first balun structure, the first balun structure is located on the first surface, the first balun structure is connected to the first radiator and a corresponding first impedance adjustment section, a length of the first balun structure is 1/4 times the wavelength of the frequency band.

7. The antenna module according to claim 5, wherein each of the balun components comprises a second balun structure, the second balun structure is located on the second surface, the second balun structure is connected to the second radiator and a corresponding second impedance adjustment section, a length of the second balun structure is 1/4 times the wavelength of the frequency band.

8. The antenna module according to claim 1, wherein a length of each antenna unit is 1/2 times the wavelength of the frequency band.

9. The antenna module according to claim 1, wherein a length of each of the two first radiators and the two second radiators is 1/4 times the wavelength of the frequency band.

10. The antenna module according to claim 1, wherein a distance between the two antenna units is less than 0.6 times the wavelength of the frequency band.
